(19) United States
(12) Patent Application Publication
(10) Pub. No.: US 2006/0289104 A1
(43) Pub. Date: Dec. 28, 2006

(54) Modular drip pan system

(76) Inventor: Daniel J. Haggerty, Morristown, NJ (US)

Correspondence Address: Thomas L. Adams, P.O. Box 340, 120 Eagle Rock Avenue, East Hanover, NJ, 07936, US

(21) Appl. No.: 11/093,327

(22) Filed: Mar. 29, 2005

Related U.S. Application Data
(60) Provisional application No. 60/557,304, filed on Mar. 29, 2004.

(51) Int. Cl. B32B 37/00

(52) U.S. Cl. 156/60

(57) ABSTRACT

A linear semicircular trough is fabricated with intermittent vertical diaphragms placed crosswise. The diaphragms are fabricated with circular openings to permit secure placement of pipes within. The various lengths of drip pans are connected with semicircular sleeves of larger diameter bonded to the outside of the ends of the two drip pans being connected. Facility for conduction and drainage of leaked liquids is provided.

The present invention is described in a provisional patent filed in Mar. 29, 2004 by the same inventor. That patent was filed under patent application No. 60/557,304.

### BACKGROUND OF THE INVENTION

1. Field of the Invention

The present invention relates to the fabrication of drip pan systems in a kit form for manual assembly on site for the support of pipes carrying process liquids, especially caustic and acidic liquids, and the collection and secondary containment of such liquids in the event of leakage. Drip pan systems are commonly used in process plants, especially water treatment plants. They are also used as underground secondary containment systems for the capture and containment of gasoline, diesel and heating fuels in underground installations.

2. Prior Art

The construction of drip pan systems usually consists of joining rectangular sections of channel shaped troughs that are suspended from the ceilings of the structures within which they are located. These troughs are designed to support pipes at intervals in such fashion as to provide a continuous and semi-enclosed path for the pipes. In addition to physical support of the pipes, the drip pans also provide containment of any leakage from the pipes.

Typically, these rectangular drip pans are fabricated from fiber reinforced polyester, or fiberglass, also known as FRP. FRP consists of any number of reinforcing layers of either glass fabric or random fibers laid upon a mold. This glass reinforcing is then saturated with liquid polyester or vinylester resin. When the assemblage cures it forms a solid composite material suitable for a variety of uses, particularly in the water treatment industry, or in corrosive environments.

Fiberglass drip pans are fabricated manually by the open mold process, a time consuming method. After fabrication of the drip pan sections, the pieces are brought to the intended location, and then joined together with overlapping layers of fabric and polyester resin. The sections are typically joined together using a manual application process, also known as the ‘bucket and brush” method. Splicing the sections together with the same resin and reinforcing is done in order to maintain the structural integrity, corrosion resistance arid containment capability of the trough system. The drip pans are joined together in the field, a procedure that is time consuming, prone to errors, and a -process for which it is difficult to guarantee results.

What is more, the method currently employed necessarily causes the release of volatile organic compounds into the atmosphere, since this joinery is performed either in the open air or in facilities not equipped to remove these compounds from the air.

There do exist drip pan systems that utilize either rectangular or semi-circular cross sections. however none provides for both support of individual pipes and a method of conducting leaked fluids to a containment location. There also does not appear to be a system that allows the joining of trough sections in the field to be performed in an easy and effective manner.

### SUMMARY OF THE INVENTION

The principal object of the invention is to provide a systematized approach to the creation of drip pans, also known as secondary containment systems that utilizes factory made components, as shown in the attached drawings.

### DESCRIPTION OF THE DRAWINGS

FIG. 1 shows a section of drip pan with a single pipe carried by two diaphragms.

FIGS. 2 and 3 show several possible embodiments of the drip pan design.

FIG. 4 shows the drip pan with the matching connector piece shown above it.

FIG. 5 shows the ends of two drip pan sections joined to the splice piece, with diaphragms omitted for clarity.

FIG. 6 is a sectional view showing a drip pan and a splice piece, with diaphragms omitted for clarity.

FIG. 7 shows the drip pan being supported by a pipe hanger, with diaphragms omitted for clarity.

FIG. 8 shows the drip pan m subterranean use, with the overhead cover shown, and diaphragms omitted for clarity.

FIG. 9 shows the drainage pipe attached to the low point of the drip pan and the flange block, 11 for attachment to the underside of the drip pan.

FIG. 10 shows a sectional view through the drainpipe flange block.

### DETAILED DESCRIPTION OF THE INVENTION

There is provided a semi-circular trough fabricated from a round tube of fiberglass that has been cut in half lengthwise FIG. 1. The primary method of fabricating the drip pans is by automatic machinery in a process known as pultrusion, rather than fabricating by the conventional method called open molding, which has remained essentially unchanged for over 60 years. There are numerous companies that fabricate pultruded fiberglass, most notably the Strongwell corporation.

Thus the benefits of machine manufacture such as high-production rates and dimensional consistency accrue to this system. Other methods of fabrication commonly used in industry such as compression molding, vacuum forming, injection molding, or indeed any other non-manual fabrication system are also contemplated.

Although high performance specifications in certain environments absolutely prohibit metal to be used as a component in drip pans, it is also contemplated that the drip pans can be fabricated for certain applications out of metal or other appropriate materials capable of being formed in the manner described herein. These would utilize the same geometry as described for fiberglass drip pans, but would be suitable only for less demanding service, for example the containment of pipes carrying water, or other materials such as Diesel fuel.

In the event that some protection were required for a drip pan system fabricated of metal, the hand applied vinylester resin called Flake-Rez described in this invention for coating fiberglass drip pans would also be used to coat the metal drip pans.

An additional benefit of this invention is that the use of the pultrusion process has the effect of substituting a more modem and controlled process in place of the current manual method. The manufacture of fiberglass necessarily releases styrene monomers into the atmosphere. The EPA considers styrene a hazardous material. On a comparative basis, Pultrusion releases less styrene into the atmosphere than the open molding process.

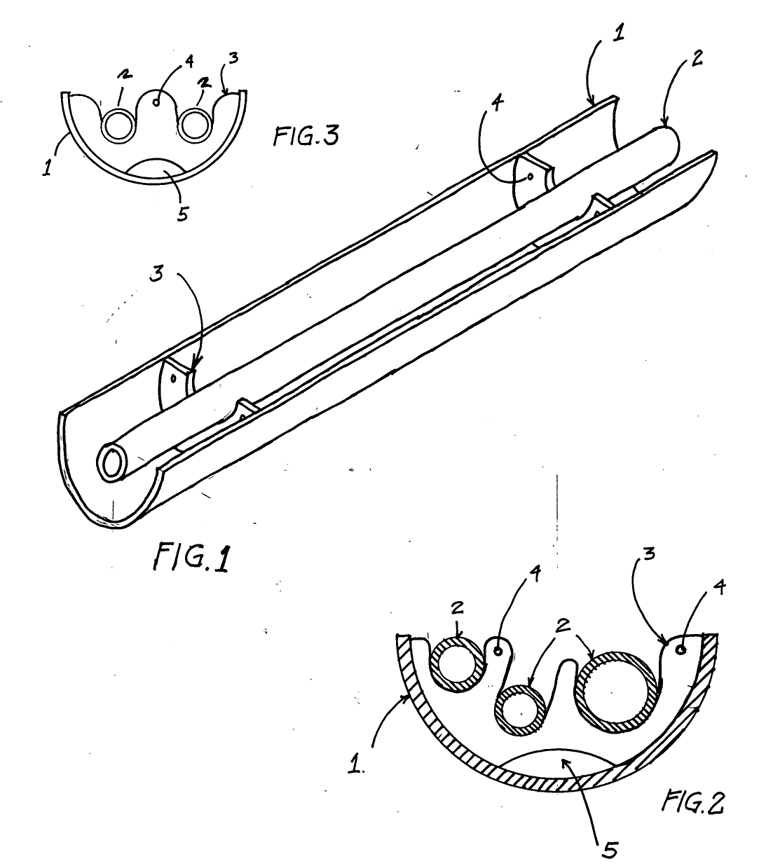

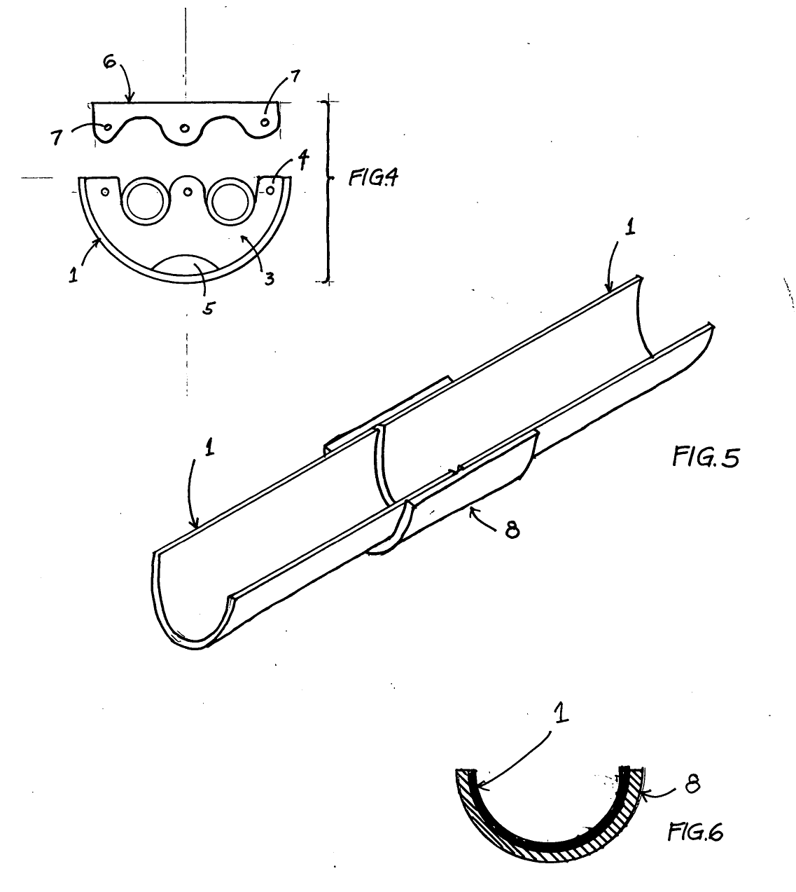

Into the aforementioned semi-circular trough is placed at intervals vertical support walls or diaphragms in a cross-wise fashion FIG. 1, FIG. 2., FIG. 3, FIG. 4. The diaphragms are fabricated from pultruded fiberglass sheets of or other suitable material with cutouts corresponding to the outer diameter of the pipes to be carried 3. FIG. 2. These cutouts are shaped such tat the diaphragms act as a series of cradles for the support of the pipes. These cradles support the pipes at a specified distance form the lower surface of the drip pan and serve to maintain a specified distance clearance between the pipes. To function suitably as cradles, the fiberglass sheets from which the diaphragms are fabricated are typically of a substantial thickness, such as ⅜″ or greater. Fiberglass diaphragms can also be used with metal drip pans, as the adhesive used to attach the components in this system are capable of attaching dissimilar materials such as metals to fiberglass. Similar pipe-holding brackets are shown in U.S. Pat. No. 4,899,964, however this is a different application and there is no containment contemplated in this patent.

A patent relating to similar containment systems hypothetically describes a requirement of continuous support for pipes when the support material is fiberglass (U.S. Pat. No. 5,590,690). Plumbing codes specify the required distance between supports for various diameters of pipes carrying the subject liquids. These supports are not required by the code to be continuous. The spans specified in codes for the support of PVC pipes, for example, between supports vary from five to eight feet for typical pipe diameters, such as ¾″ to six inch pipes.

Fiberglass pipes as described in this invention are sufficiently strong to provide support to the smaller pipes being carried on the intermittently placed support diaphragms. The pipes being carried by the drip pans are supported by the intermittent support diaphragms FIG. 1. These diaphragms are paced at code-determined intervals. Support of the drip pan itself is a separate issue.

The loads transmitted from the support diaphragms to the drip pans must not exceed the capability of the fiberglass drip pan itself, or cause undue deflection of the drip pan. The determination of these loads and the selection of an appropriate size of drip pan tube is a standard engineering exercise and yields an optimum spacing of the overhead support hangers as a solution. The drip pan system is then specified and designed accordingly. There is no inherent limitation on the use of fiberglass as a drip pan material as suggested in the aforementioned patent, U.S. Pat. No. 5,590,690.

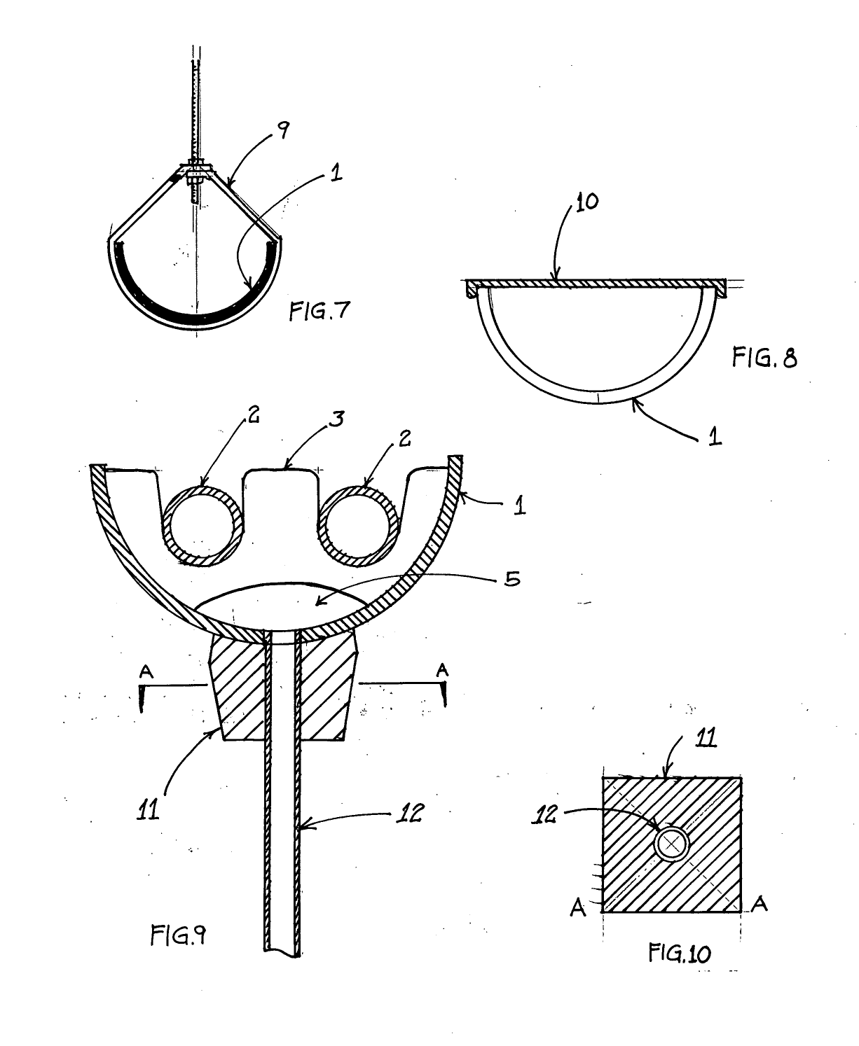

The same factors apply to the contemplated metal drip pan system described in this invention. The drip pan is designed so that the pipe loads are sufficiently supported by the diaphragm and the drip pan load is supported by the overhead hangers, 9 shown in FIG. 7.

The ability of this drip pan system to support structural loads is not a governing factor. The drip pans tubes are either sufficiently stiff to provide support for the pipe support diaphragms, or in cases of excessive loads, the hanger straps are placed co-incident with the locations of the diaphragms, and directly underneath. This practice removes the drip pan itself from any evaluation of the pipe loads.

A key aspect of the present invention is that since the support diaphragm is fabricated specifically for the pipes to be carried, the pipes can rest securely within the cradle and stay in place through gravity. FIG. 4 shows a containment clip 6 custom fabricated for each cradle that connects to each diaphragm and retains the pipes in their cradle with attachment hardware. This containment clip Is not necessary but can be used optionally where seismic or other conditions warrant its use.

While typical drip pans also utilize containment hardware, this usually consists of a c-shaped channel, often called a “unistrut” placed crosswise along the floor of the drip pan with the legs of the channel facing upward. This strut is flat horizontally, and exhibits no conformance to the size of the pipes placed upon it. The pipes are placed on the horizontal strut and are restrained in place by clips manufactured of a shape that permits the clips to hook into the strut on the bottom, one on each side of the pipe. These two clips curve up and over the pipe, and connect to each other with a nut and bolt at the top of the pipe. Such conventional pipe restraint requires no fewer than 4 discrete pieces of hardware to restrain each pipe.

For a conventional drip pan containing for example, six pipes, twelve separate pieces of hardware would be required to contain the six pipes. Six sets of nuts and bolts would also be required. The total piece count would be 24 discrete components to contain the six pipes. The present invention accomplishes the same pipe containment task as shown in FIG. 4 with one piece of containment hardware 6 and from one to three sets of nuts and bolts.

However, where access to individual pipes is required, the conventional system permits the removal of individual pipes by removal of the individual restraining system for that pipe. This is not a special advantage over the present invention. The present invention does require the removal of the entire restraining clip in order to remove a single pipe for repair. In FIG. 2 in the present invention however, the aforementioned conformal design of the support diaphragm 3 creates the previously described cradle effect, which inherently provides restraint of the pipes 2 even without a restraining clip. Recall that in the conventional system, pipes can move side-to-side across the horizontal support strut when the restraining hardware is removed, a disadvantage that does not occur in the present invention.

The present invention is also superior to conventional rectangular drip pans because the semi-circular design saves space. While the conventional design requires placement of the pipes adjacent to each other in a one-dimensional, horizontal array, the semi-circular array of the pipes in the present design utilizes a more compact circular array, with some of the pipes placed somewhat above the others, rather than next to the others FIG. 2.

There is a pipe support system described by Collins and McClellan in U.S. Pat. No. 4,765,577 that has similar geometry and characteristics to the present invention. There are crucial differences that place substantial imitations on the likely performance and applicability of theft system. Their system utilizes “U” shaped sheet metal troughs to provide continuous support of a pipe within. There is no provision for the individual support of additional pipes or different sized pipes in that system. One drawing indicates pipes nested in a square trough with the pipes merely laying on top of one another, an unsatisfactory condition in most applications.

Sheet metal requires substantial thickness to provide the kind support contemplated in this patent. It is likely there will be substantial limitations on the sizes of the pipes that can be supported.

Since the trough described herein is metal, it is contraindicated for most of the containment tasks described in the present invention. Galvanized sheet metal will react adversely to the presence of most acids and alkalais, and will generate toxic fumes when in contact with some chemicals. Fiberglass has resistance to almost all chemicals in common use, and the metal version of the present invention can be made corrosion resistant with the application of Flake-Rez. This system is apparently designed for mild materials such as water, as evidenced by the requirement for a dielectric material in the system. This requirement means that some of the material will corrode in use. The design requires joints as do the others including this invention, however the joints described are of the crimped sheet metal type, and will provide restrictions to the flow of leaked materials as described herein.

The design of the present invention provides a superior method of managing leaks, as will be explained. There are conventional systems that utilize containment vessels or drip pans with square profiles, but the collection of leaked liquids is problematic in these systems. The floor of the rectangular drip pans is flat, and slight unevenness in the surface exists across the entire drip pan where the splices occur. The requirement of field joining the drip pan sections creates this uneven surface, and permits ponding of leaks where the additional fiberglass is applied to accomplish the field splice; another barrier. An additional barrier to efficiently conducting the leaked fluids to a collection point is the crosswise location of the pipe support struts. These act as partial dams against the free flow of leaked fluids. This deficiency is evident in several US patents that describe square troughs. U.S. Pat. No. 4,682,911 also U.S. Pat. No. 4,778,310 and U.S. Pat. No. 4,518,151, all by Moreland.

While other patents, such as U.S. Design Pat. No. 307,557 utilize circular special pieces to provide a housing for the containment of leak detection systems within the circular housing, No special pieces are required in the present invention for the detection of leaks.

It is noted that U.S. Pat. No. 4,765,577 provides a drain spout integral with its trough. The design of this spout is deficient for many applications. That spout has an upper flange that bonds to the underside surface of the trough. This flange rests slightly higher than the surface of the trough, which will impede the flow of liquids into the drain spout. While this is not an issue for benign liquids such as water, it is highly problematic for corrosive materials that would have an opportunity to cause damage if they are not conducted away immediately.

The present invention shows in FIG. 9 a drain spout 12 that does not protrude above the surface of the drip pan, but provides its attachment flange 11 outside of and below the drip pan. A similar effect is achieved in the metal version of the present invention by also placing the flange outside of the drip pan.

It is observed that other square drip pans and containment troughs also utilize lap joint or tongue and groove connection systems also connected with adhesive that however necessarily permit a gap to remain through the entire cross section of the joint. The present invention is superior in that the adhesively connected gap is further sealed and protected by an additional small layer of vinylester resin covering the gap at about an inch on either side of the entire extent of the gap on the inside of the drip pan. This small layer of resin is applied by hand as a final step after the installation of the drip pans in the field.

In the conventional system, care must be exercised in the placement of the horizontal pipe supports within the drip pan. The supports must be placed at a distance from the edges of the horizontal drip pan. This requires additional width in the conventional drip pan to accommodate both the horizontal support and the free flow of leaked liquids around the support, a waste of materials and horizontal space.

Finally, these types of drip pans must often be installed with,additional sloping in order to overcome these inherent flow restrictions. This additional sloping has the negative effect of consuming vertical space at the installed location.

The present invention shows in FIGS. 2, 3, 4 & 9 an arch shaped opening 5 at the bottom of the diaphragm 3. This opening permits leaked liquids to flow freely under the diaphragm and flow to the drain pipe and collection point. The cutout being in the shape of an arch, utilizes the force of compression to efficiently direct the loads applied to the individual diaphragm down to the walls of the drip pan trough and thence to the exterior supports.

The present invention permits the drip pans to be installed with less slope in order to permit conduction of leaked liquids. This requires that less vertical space be utilized in order to accommodate this slope than with a conventional system.

It is also stated that the present invention, while described for above ground use in an open-air application, can be used in other ways. An additional embodiment of the invention is as an embedded secondary containment system for underground applications.

In this application, the same elements that are contemplated in the suspended system are used FIG. 8, with the addition of a top closure piece 10 fabricated of the same vinylester fiber-reinforced plastic, or other suitable material that forms a continuous cover over the exposed upper portion of the drip pan, and is bonded to the drip pan. Where the gaps in the top cover pieces occur, a splice piece of similar material analogous to the semi circular splice pieces for the drip pans is contemplated. This splice piece would be attached over the gap in the cover pieces with the same adhesive used for the drip pans. The underside of the cap pieces can also be surfaced with the same graphite-impregnated vinylester resin as used on the drip pans themselves, if required.

The underground containment and drip pans system can be installed in sand or gravel beds to provide support for the network of drip pans, similar to conventional methods of supporting such pipe troughs as is common in the construction industry.

Several U.S. patents describe a similar underground system. U.S. Pat. No. 4,653,958 describes “A Modular Secondary Containment Kit for Housing Pipelines”. This system has troughs with square profiles, which has been discussed here as not conducive to collection of leaked liquids. This patent also is similar to U.S. Pat. No. 4,968,179. Both of these patents require that the drip pan, or containment trough be filled with aggregate material to support the pipes. This can be considered unsatisfactory in that the removal and servicing of pipes becomes a costly and difficult process.

A full containment system is described in US patent #2001/0006071 A1. This system describes a pipe-within-a-pipe system where the larger pipe is actually a pressure jacket designed to contain fluids or gas under pressure. Such requirement is not contemplated here.

Moreland, previously cited, describes an additional underground containment system for gasoline and other fuels in his three US Patents. All of these describe a system of containment fabricated from a membrane. The membrane is temporarily supported while being installed until the excavated soil can be returned. This system obviously requires permanent support and could not function in an aboveground capacity.

While conventional systems contain inherent barriers to smooth flow of liquids, the proposed invention eliminates these problems through the choice of superior geometry for the drip pan components. The semi-circular design of the drip pans forms a trough that naturally conducts liquids down the sides of the drip pan towards the center of the pan at the bottom of the trough. This consolidation of the leaked liquids has the effect of hastening their flow to the appropriate collection point.

Each of the pipe support diaphragms also contains a cutout at its lower portion such that leaked fluids are easily permitted to flow under and past the diaphragms at the lowest level of the drip pan, where the smooth flow of the consolidated liquids will naturally occur.

The drip pans 1, FIG. 5 are joined together end to end to maintain the semi-circular cross section. While conventional drip pans are joined with hand lay-up field splices of fiberglass, the present invention utilizes a simpler system. The ends are spliced together with a satisfactory adhesive, for example acid resistant methyl-methacrylate structural adhesive. The ITW Plexus corporation manufactures an acid resistant adhesive called Plexus #420. It should be noted that while methyl-methacrylate is also a hazardous material, it is considered less hazardous than styrene monomer, and will be used in much reduced quantity than an equivalent amount of styrene monomer to achieve joining of the drip pan sections. The net effect is to reduce the amount of hazardous material introduced into the atmosphere.

Conventional splices require lapping of the resin and fiberglass fabric many inches on either side of the inside of the joint, the structural adhesive permits an interior joint of only ⅛ of an inch. While the conventional system requires a lap joint that creates an uneven surface, the adhesive can be smoothed down such that the seam at the joint is flat. In addition to the adhesive at the butt joint, the present invention utilizes splice pieces 8 in FIG. 5, 8 in FIG. 6 in the form of semi-circular sleeves made of pipe sections of varying length that are slightly larger in diameter than the drip pans themselves. The inside profile of the splice pieces conform exactly to the outside profile of the drip pan, creating a nesting effect. A slight gap is provided between the two to permit space for the adhesive to create a tight bond.

Additional pieces such as 90 degree or other turns, “Y” pieces, “T” pieces and end pieces are also contemplated within this system. These pieces can be fabricated by open molding, pultrusion, or other processes such as vacuum forming, or pressure forming or any other commonly used method of fabricating fiberglass, other plastic components, or metal.

The splice pieces are designed in lengths sufficient to provide adequate surface area for adhesion to the exterior of the drip pan and support of the drip pan at the splice, typically three to six inches on either side of the joint. The splices are attached to the joined sections of drip pan with the same structural adhesive described above. It is noted here that the metal drip pan system uses the same geometry such that the straight ends of the drip pans are spliced with an outside sleeve-like fitting. This is also bonded to the drip pan ends with methyl-methacrylate adhesive. As with the fiberglass drip pan system, the joints in the metal drip pan splices are made smooth to permit flow of leaked liquids. If the application requires, the metal drip pan system can be covered with the Flake-Rez resin coating, which adheres well to metals.

The conventional system requires connecting the joints between the drip pans by lapping fiberglass fabric over the joint with the same resin as the drip pans themselves to maintain the structural integrity of the system. The lapping is also done to provide a corrosion barrier that is equal to the corrosion barrier provided in the drip pan sections themselves. Vinylester is the most suitable resin for providing a corrosion resistant barrier in fiberglass drip pans, and is also used to splice the drip pan sections.

Vinylester resin however, cannot be used alone to achieve corrosion resistance. It requires the use of glass fabric to provide a structural matrix for itself to adhere to while it cures. The present invention utilizes a custom designed resin system that contains an inherent structural matrix, and does not require a fiberglass matrix. This matrix is manufactured by the PolySpec Corporation and is called Flake-Rez. This resin is composed of microscopic graphite flakes that bind with the vinylester resin to provide the necessary structural matrix. By use of this special resin, this invention also provides a corrosion barrier.

Note that while this invention requires the use of hand-applied resin that releases VOC's into the atmosphere, the net effect of the entire process still releases fewer VOCs into the atmosphere than the conventional method.

The graphite structural matrix allows the vinylester resin corrosion barrier to be applied like paint in the factory. The use of this special vinylester resin in the present invention permits a much higher degree of flexibility of design and fabrication than the conventional system that requires hand lay-up. It is also noted that the use of the hand applied vinylester resin permits the sealing of the gap between the drip pan sections, after that gap has been flooded with the adhesive and the adhesive has been scraped form the gap to provide a smooth joint. In this manner the integrity of the corrosion barrier has been maintained.

In a process plant such as a water treatment facility, the conventional support system for rectangular drip pans requires the use of custom hardware to accomplish attachment to the ceiling. Typically this consists of a cross piece of angle or other horizontal support upon which the square drip pan rests. At either end of the horizontal support, two lengths of threaded rod are attached that are suspended from the ceiling. This requires two discrete attachment points at the ceiling. The present invention is superior to the conventional method in this regard also as the circular nature of the design permits the use of conventional pipe hangers 9, FIG. 7 for support. These pipe hangers are fabricated in varying diameters and correspond to the diameters of the semi-circular drip pan sections in the present invention. These hangers are fabricated in the form of circular straps that form a circular cradle for the supported pipe. The straps are connected to a single threaded rod suspended from the ceiling in the same manner as the conventional system. The present invention has the beneficial effect of reducing the number of ceiling connections required in a drip pan system by half.

1. A method of fabricating drip pans and secondary containment systems from manufactured components.

2. A method according to claim 1 of joining drip pan and secondary containment system components with adhesive and manufactured splices.

3. A method according to claim 1 of supporting pipes in a semi-circular array.

4. A method according to claim 1 of supporting pipes that utilizes less space than conventional methods.

5. A method according to claim 1 of supporting pipes that does not require attachment hardware to contain the pipes.

6. A method according to claim 1 of supporting pipes that does not impede the flow of leaked liquids within the drip pan or other containment vessel.

7. A method according to claim 1 of fabricating drip pans and secondary containment systems that permits the installation of drip pans and secondary containment systems with less slope than with conventional systems.

8. A method according to claim 1 of restraining the pipes contained within the drip pan that requires a single component and a minimum of fasteners.

9. A method according to claim 1 of providing a corrosion resistant baffler on the inside of drip pans and secondary containment systems.

10. An method according to claim 1 of fabricating drip pan and secondary containment systems that causes a reduction in the emission of harmful substances into the atmosphere.
